(19) United States
(12) Patent Application Publication
(10) Pub. No.: US 2001/0025271 A1
(43) Pub. Date: Sep. 27, 2001

(54) Commercial transaction system and method for protecting the security and privacy of buyers transacting business over a communication network

(76) Inventor: Douglas G. Allen, Sonoma, CA (US)

Correspondence Address: FOLEY & LARDNER, ONE MARITIME PLAZA, SIXTH FLOOR, SAN FRANCISCO, CA, 94111, US

(21) Appl. No.: 09/737,208

(22) Filed: Dec. 13, 2000

Related U.S. Application Data
(60) Provisional application No. 60/170,851, filed on Dec. 14, 1999.

(51) Int. Cl. H04K 1/00; H04L 9/00

(52) U.S. Cl. 705/65

(57) ABSTRACT

A commercial transaction system and method for enabling a buyer to purchase goods over a communication network, such as the Internet, without disclosing the buyer's credit information or identity to the seller. The invention is implemented by utilizing a unique Confidential Transaction Number (“CTN”) which replaces the buyer's credit/debit card number as the means of paying for a seller's goods selected for purchase by the buyer over the network. The unique CTN is issued by a Confidential Transaction Provider to the buyer for each transaction. Prior to issuing the CTN, the Confidential Transaction Provider obtains the buyer's credit/debit card information and determines from buyer's credit/debit card company if buyer has sufficient credit to cover the amount of the purchase. If so, the Confidential Transaction Provider preliminarily approves the buyer's credit for the purchase and sends the unique CTN to the buyer's computer over the network. The buyer may then use the CTN, to purchase the specific goods being offered for sale. The sale is consummated by having the buyer provide the unique CTN over the network to the seller. The seller then contacts the Confidential Transaction Provider to verify that the CTN was actually issued to the buyer and to disclose the amount of the purchase. If the Confidential Transaction Provider verifies the CTN and the amount of purchase, the Provider rechecks the buyer's credit for sufficient funds, and if the buyer's credit is still adequate, charges buyer's account for the purchase amount, credits the seller's account, and the seller delivers the goods to the buyer. The CTN may also be used by a shipper to identify the goods to be picked from the seller and to pay for the delivery of the goods.

This invention relates and refers to a previously filed provisional patent application, bearing No. 60/170,851, and filed on Dec. 14, 1999.

### TECHNICAL FIELD

This invention relates to the field of electronic commerce and, specifically, to protecting the financial security and privacy of users engaging in electronic business transactions.

### BACKGROUND OF THE INVENTION

Since the dawn of civilization and in particular since the advent of a barter system, the exchange of goods and services has been conducted on a face-to-face basis. Ultimately, the barter system evolved into a monetary system in which money and commercial paper were used to facilitate the transfer of goods or the performance of services. Again, however, the exchange of goods and services for money was normally carried out in a face-to-face environment.

The personal nature of commercial transactions first began to change most dramatically with the introduction of reliable mail delivery systems and the telephone. Wide spread use of the mail and telephone to buy goods or order services did not arise, however, until the invention of the credit card. Specifically, it was the credit card which empowered the telephone, as one of the most popular methods of engaging in commercial transactions. Indeed, the credit card has been the catalyst behind the growing trend of engaging in commercial transactions where the participants are not in a face-to-face relationship. Today, this trend has become a worldwide explosion called electronic commerce, typically called e-commerce, resulting from the use of the Internet to buy and sell products and services.

The popularity of e-commerce has arisen largely due to the fact that buying and selling over the Internet is more convenient than other more traditional commercial transaction methods. In addition, the Internet offers an almost limitless volume of goods and services for purchase and sale over a worldwide market. The success of e-commerce has not been realized, however, without also creating some problems for consumers. Most notably, the loss of security and privacy. Because buyers typically use their credit card when buying goods and services over the Internet, they must transmit their credit card number, across a public network, to someone they have never met, or to a company they have never done business with before. Thus, there is a risk that the buyer's credit card information might be obtained for fraudulent purposes by the seller. Another risk is that the credit card data is vulnerable to being stolen electronically over the Internet. Further, the buyer's privacy is invaded due to the practice of most credit card companies and sellers of tracking the customers' purchases and developing customer credit profiles which are then sold to marketing companies.

The problem of providing customers with security and privacy using the Internet has been addressed by several different methodologies. One of the first methods to be implemented involves encrypting the buyer's credit card information so that the data could only be accessed by the seller who had the code or “key” needed to unlock the correct card number. Although this method protects buyer's credit card number from being stolen electronically, its substantial limitations are that each seller must be provided the “key” to unlock the card number, and that the buyer's privacy is not protected once the seller decodes the number. Another method that has been developed involves having the buyer provide his or her credit card information to an Internet Service Provider (“ISP”) who then enters into an agreement with the seller which enables a sale to be consummated without the ISP being required to divulge the buyer's identity or credit card information to the seller. An obvious drawback of this last method is that the ISP has to enter into multiple agreements with multiple sellers in order to consummate a sale. An attempt to overcome this limitation was addressed by the method disclosed in U.S. Pat. No. 5,899,980. Rather than require that agreements be reached between an ISP and sellers, the '980 patent discloses that computer software is provided by a trusted third party to both the ISP and the seller. The software functions to identify the Internet address location of the ISP and seller and stores the information in a database maintained by the trusted third party. In order to consummate a transaction, the ISP communicates a purchase request to the trusted third party which matches the address of the ISP to the seller and then contacts the seller with the purchase request. In this fashion, agreements between the ISP and seller are eliminated. Unfortunately, however, the '980 patent has its own serious limitation in that it requires that all potential ISPs and sellers be provided with the trusted third party's software. In addition to the problem of having to provide the software to an enormous number of ISPs and sellers, the software installation problems are nearly insurmountable in that the software must be customized to run on a multitude of different computer platforms.

It is of one of the objects of the present invention to overcome the limitations of the prior art discussed above.

### SUMMARY OF THE INVENTION

The present invention provides a new and unique system and method for enabling a buyer to purchase goods and/or services over a communication network, such as the Internet, without disclosing the buyer's credit information or identity to the seller.

In general, in the preferred embodiment, the invention is implemented by means of the creation of a unique Confidential Transaction Number (“CTN”) which replaces the buyer's credit/debit card number as the means of paying for a seller's goods or services selected for purchase by the buyer over the network. The unique CTN is issued by a Confidential Transaction Provider to the buyer for each transaction. Prior to issuing the CTN, the Confidential Transaction Provider obtains the buyer's credit/debit card information and determines from buyer's credit/debit card company if buyer has sufficient credit to cover the amount of the purchase. If so, the Confidential Transaction Provider preliminarily approves the buyer's credit for the purchase and sends the unique CTN to the buyer's computer over the network. The buyer may then use the CTN, just like a credit card number to purchase the specific goods or services being offered for sale.

The sale is consummated by having the buyer provide the unique CTN over the network to the seller. The seller then contacts the Confidential Transaction Provider to verify that the CTN was actually issued to the buyer and to disclose the amount of the purchase. If the Confidential Transaction Provider verifies the CTN and the amount of purchase, the Provider rechecks buyer's credit for sufficient funds, and if buyer's credit is still adequate, charges buyer's account for the purchase amount and credits seller's account.

In addition to protecting the buyer's credit/debit card information from disclosure, another aspect of this invention maintains the confidentiality of the buyer's identity and address when the delivery of goods are involved. In this instance, at the time the buyer first contacts the Confidential Transaction Provider to purchase the goods, buyer informs the Provider that he/she wants to have the goods shipped to buyer without disclosing buyer's name and address to the seller. The buyer obtains the benefits of this aspect of the invention by providing the Confidential Transaction Provider with the weight of the goods to be shipped, the location of where the goods are to be picked up, and the address of where the goods are to be delivered. The Confidential Transaction Provider calculates the approximate cost of shipment and verifies that the buyer's credit/debit account is sufficient to pay for the shipment. If buyer's credit is sufficient to pay for the cost of shipment, the value of the CTN is increased by the amount of the additional shipping cost. The CTN is then used in the same manner as disclosed above; however, the CTN's increased value will be used by the Confidential Transaction Provider to pay a Shipment Service Provider to pick up the goods from seller and deliver them to buyer.

It should be readily appreciated that the present invention overcomes all of the limitations of the known prior art. No special contractual agreements involving ISPs and sellers are necessary, and no special software must be provided to sellers and ISPs. In fact, the present invention does not even require that an ISP be part of the transaction. The present invention also accomplishes the objective of enabling a buyer to purchase goods or services over a communication network without requiring that he or she disclose their identity or credit information to the seller, and without disclosing to the buyer's credit/debit card company the identity of the goods or services being purchased.

Another aspect of this invention is that it enables a buyer to consummate a purchase over time by making periodic payments to the seller. Once the buyer and seller agree on the frequency and amount of buyer's periodic payments, the buyer notifies the Confidential Transaction Provider which issues to buyer a unique CTN for each periodic payment. Upon receipt of each CTN, the buyer sends the CTN to the seller who then contacts the Provider to confirm that the CTN is authentic and that the buyer has sufficient funds to pay for the goods or services.

In addition to protecting the buyer from disclosing his or her identity and credit/debit account number to the seller, it should be readily understood that the present invention also prevents the buyer's credit/debit card company from determining what is being purchased, since from the credit/debit card company's perspective the sale is being made by the Confidential Transaction Provider, rather than the seller. As a result, the credit/debit card company cannot identify the buyer to the purchase of specific goods and/or services, which is the type of demographic information that credit/debit card companies normally provide to other companies for marketing purposes. Finally, it will be understood by those skilled in the art that the network transmission of buyer's credit/debit account number from the Confidential Transaction Provider to the credit/debit card company may be accomplished, if desired, by using any one of several encryption schemes accepted by the credit/debit card company.

### BRIEF DESCRIPTION OF THE FIGURES

FIG. 1a is a block diagram of a commercial transaction system and method, in accordance with this invention, for protecting the security and privacy of a buyer buying goods or services from a seller over a communication network.

FIG. 1b is a block diagram of the commercial transaction system and method, in accordance with this invention, in which the buyer elects to use the services of a confidential shipper to pick up goods from seller and deliver them to buyer.

FIG. 2 is a diagrammatic illustration of the invention which more specifically describes the manner in which the invention is implemented over the Internet.

FIG. 3 is a flow chart illustrating this invention from the buyer's perspective and the steps which are performed by the buyer in using the invention.

FIG. 4 is a flow chart illustrating this invention from the seller's viewpoint and the steps which are carried out by the seller in using the invention.

FIG. 5 is a flow chart illustrating this invention from the confidential shipper's perspective and the steps which are performed when the shipment of goods, as shown in FIG. 1b, is involved.

FIG. 6 is a flow chart showing this invention from the perspective of the buyer's credit/debit card company.

FIG. 7 is a table which contains information about a buyer which is stored in a database as a Buyer's Record.

FIG. 8 is a table which contains information about a seller which is stored in a database as a Seller's Record.

FIG. 9 is a table which contains information about a buyer's credit cards which is stored in a database as a Credit Card Record.

FIG. 10 is a table which contains information about a specific financial transaction, including the issuance of the Confidential Transaction Number, which is stored in a database as a Financial Transaction Record.

FIG. 11 is a table which contains shipping information which is stored in a database as a Shipper Record.

### DETAILED DESCRIPTION OF THE INVENTION

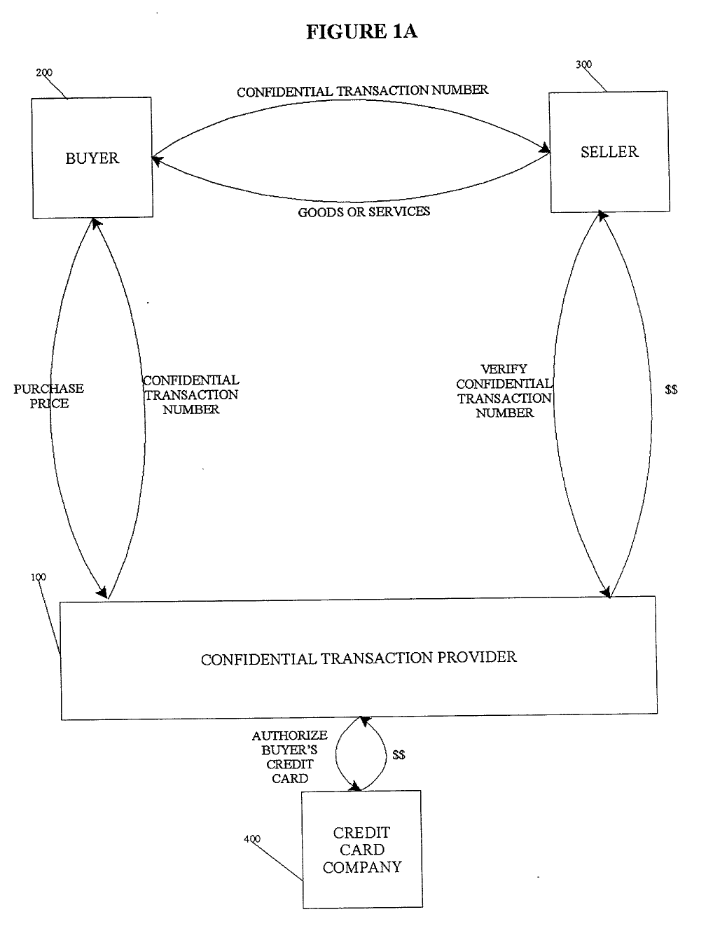

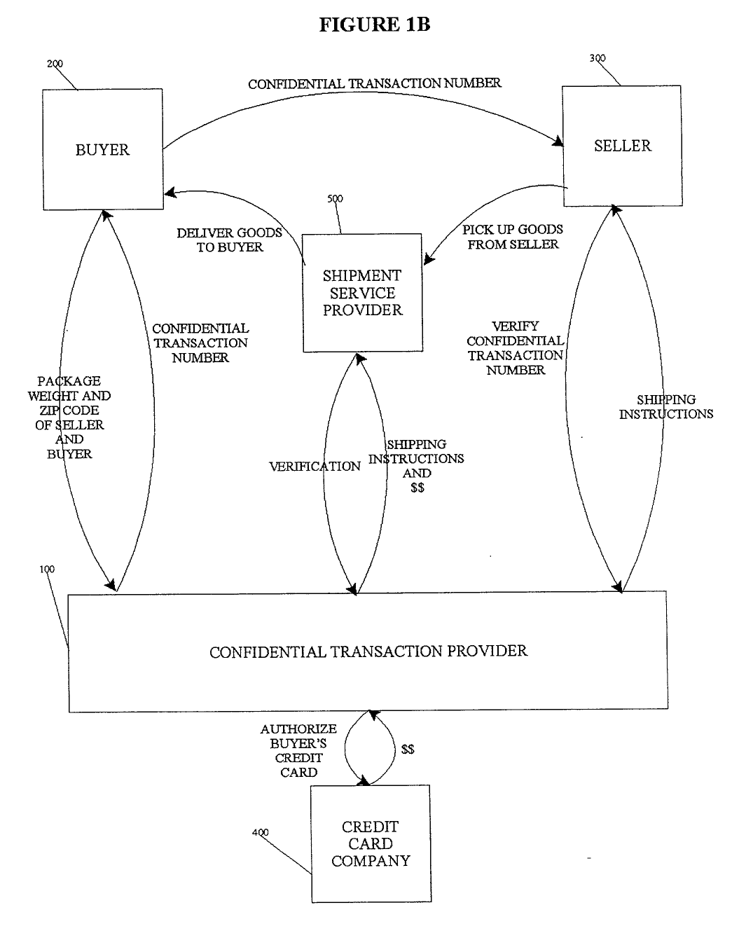

FIG. 1a generally illustrates a commercial transaction system and method in accordance with this invention, enabling a Buyer 200 to purchase goods and/or services over a communication network, such as the Internet, without disclosing the buyer's credit information to the Seller 300, and without disclosing to the buyer's credit/debit card company the identity of the goods or services being purchased. Initially, a Confidential Transaction Provider 100 is contacted over the communication network by a Buyer 200 who desires to utilize the Provider's services to purchase goods and/or services from a Seller 300 who is offering the goods and/or services for sale over the network. If the Buyer 200 is not already registered as an authorized user, the Confidential Transaction Provider 100 registers Buyer 200 and obtains, among other things, credit/debit card information from Buyer 200 over the telephone, or the information can be sent by facsimile or mail. The buyer's credit/debit card account information may also be transmitted over the communication network; however, in order to prevent the buyer's account information from the possibility of being misappropriated, the Confidential Transaction Provider 100 may provide Buyer 200 with the means for transmitting the information using an encryption scheme, such as Secure Sockets Layer encryption. Once registered, the Confidential Transaction Provider 100 also obtains from Buyer 200 the purchase price of the goods and/or services. The Confidential Transaction Provider 100 next contacts buyer's Credit Card Company 400 to verify that Buyer 200 has sufficient funds or credit to consummate the proposed purchase. If the buyer has sufficient funds or credit, the Confidential Transaction Provider 100 issues Buyer 200 a Confidential Transaction Number (“CTN”). The value of the CTN is equal to the purchase price of the goods or services plus a transaction fee to be charged by the Confidential Transaction Provider 100. On the other hand, if buyer's funds or credit is insufficient, he or she is notified of that fact and the transaction is denied.

Once Buyer 200 obtains the CTN, he or she is prompted to provide the CTN over the commercial network to the Seller 300 to indicate a desire to purchase the good/services and to use the CTN as the method of payment. The Seller 300 next uses the commercial network to contact the Confidential Transaction Provider 100 to verify that the CTN was issued to Buyer 200 and that the buyer's credit is sufficient to cover the value of the CTN. If the Seller 300 has not previously registered with the Confidential Transaction Provider 100, Seller 300 is registered by establishing a seller's account with the Confidential Transaction Provider 100. In order to protect the seller's account information, the Confidential Transaction Provider 100 may also provide the Seller 300 with an appropriate encryption scheme. Once registered, the Confidential Transaction Provider 100 verifies that the CTN provided to Seller 300 matches the CTN provided to Buyer 200 by the Confidential Transaction Provider 100, and again verifies that Buyer 200 has sufficient funds or credit to cover the value of the CTN. If the Buyer 200 is not now creditworthy or the CTN is invalid, the Seller 300 is notified that the transaction is terminated. If the CTN is valid and the buyer still has sufficient funds or credit, the Confidential Transaction Provider 100 requests that the Credit Card Company 400 charge payment account of Buyer 200 for the amount of the CTN. The Credit Card Company 400 transfers funds from the payment account to a trust account of the Confidential Transaction Provider 100, and the Confidential Transaction Provider 100 in turn transfers that portion of the CTN which represents the purchase price to an account of the Seller 300, and the Confidential Transaction Provider 100 retains the balance of the CTN as its transaction fee.

FIG. 1b illustrates another aspect of the present invention in which only the sale of goods is involved, and the Buyer 200 also does not want to disclose his/her identity to the Seller 300 for the purpose of shipment of the goods. In this instance, at the time Buyer 200 first contacts the Confidential Transaction Provider 100 to purchase the goods, Buyer 200 informs the Provider 100 that he/she wants to have the goods shipped to Buyer 200 without disclosing buyer's name and address to the Seller 300. The Buyer 200 obtains the benefit of this aspect of the invention by providing the Confidential Transaction Provider 100 with the weight of the goods to be shipped, the location of where the goods are to be picked up, and the address of where the goods are to be delivered. The Confidential Transaction Provider 100 calculates the approximate cost of shipment and verifies that the buyer's credit/debit account is sufficient to pay for the shipment. If buyer's credit is sufficient to pay for the cost of shipment, the value of the CTN is increased by the amount of the additional shipping cost. The CTN is then used in the same manner as disclosed in FIG. 1a to purchase the goods from Seller 300; however, the CTN's increased value will be used by the Confidential Transaction Provider 100 to pay a Shipment Service Provider 500 to pick up the goods from Seller 300 and deliver them to Buyer 200. When the Seller 300 contacts the Confidential Transaction Provider 100 to verify the authenticity of the CTN, the Seller 300 also discloses the location and weight of the goods. Upon receipt of this information, the Confidential Transaction Provider 100 determines whether the location and weight of the goods matches the information received from Buyer 200. If the shipping cost and logistics are verified, the Confidential Transaction Provider 100 rechecks buyer's credit, and if still adequate, the Confidential Transaction Provider 100 contacts a Shipment Service Provider 500 to pick up the goods from Seller 300 and deliver them to Buyer 200. In the preferred embodiment, the Shipment Service Provider 500 will use the CTN to identify the goods to be picked up from Seller 300. Payment is made by the Confidential Transaction Provider 100 by requesting that the Credit Card Company 400 charge buyer's account in an amount equal to the increased value of the CTN. The Credit Card Company 400 then transfers these funds from the account of Buyer 200 to the trust account of the Confidential Transaction Provider 100, and the Confidential Transaction Provider 100 in turn pays the Shipment Service Provider 500. Upon receipt of its payment, the Shipment Service Provider 500 picks up and delivers the goods to Buyer 200.

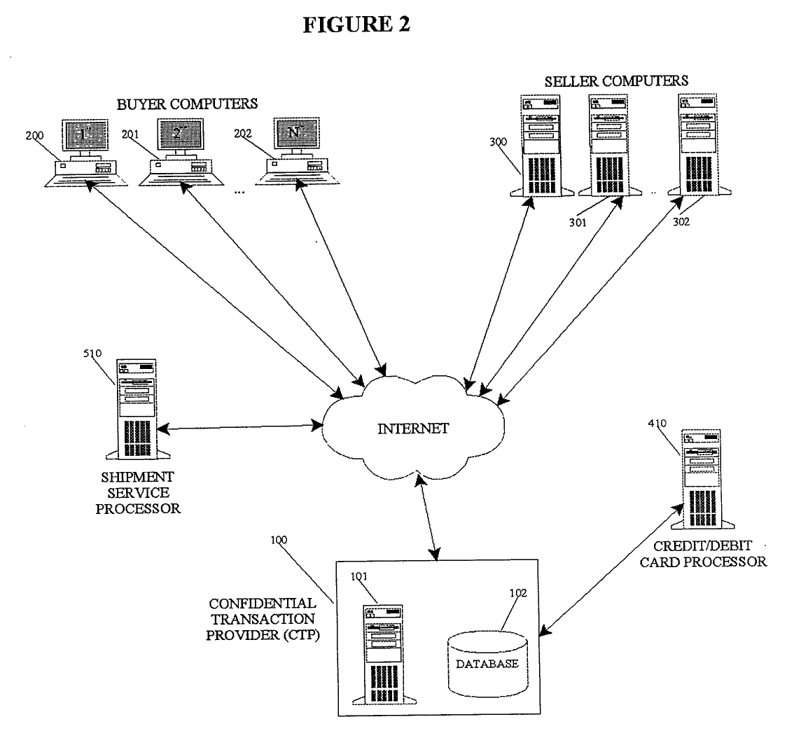

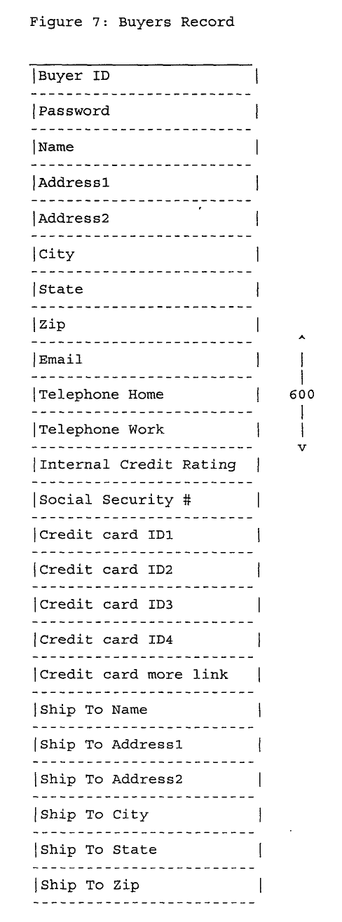

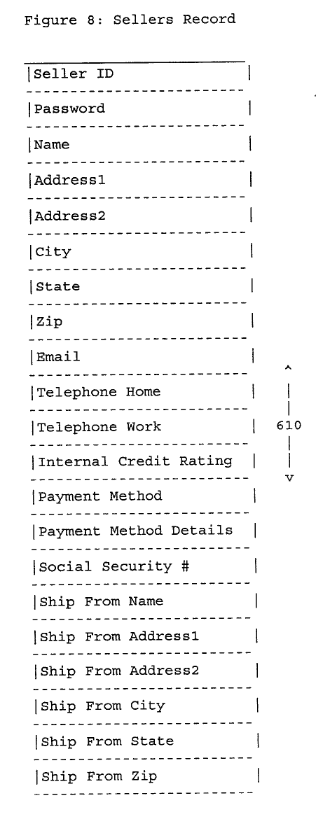

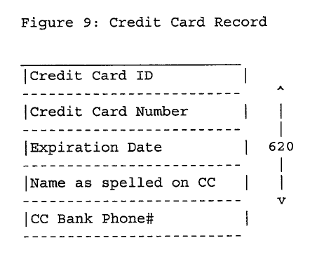

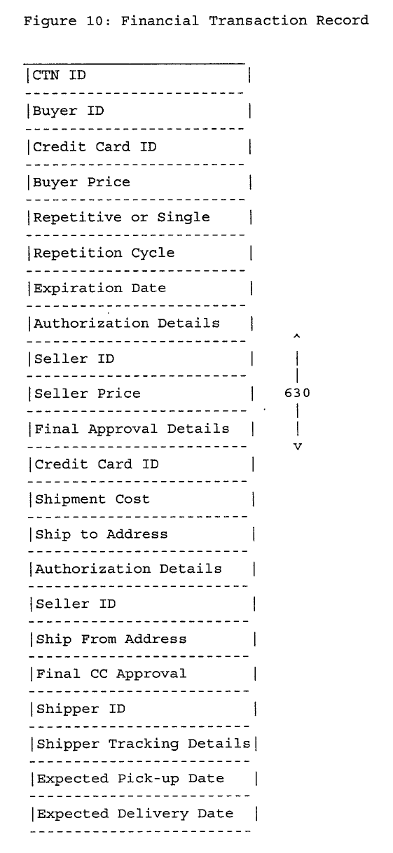

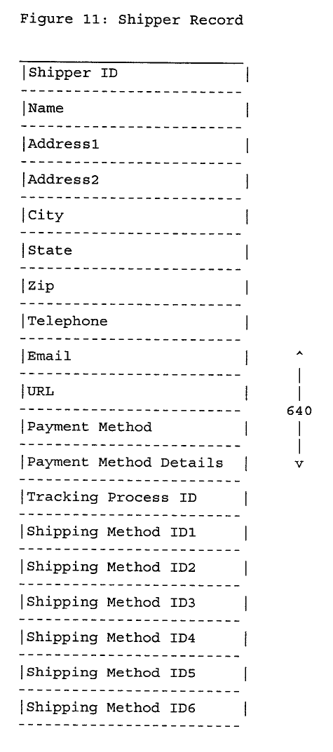

FIGS. 2 through 11 generally illustrate the present invention as disclosed in FIG. 1a and 1b when the communication network is the Internet and the transfer of funds to purchase the goods and/or services is consummated using computers coupled to that network. More specifically, FIG. 2 shows one or more Buyer Computers 210(1), 210(2) . . . 210(n) connected over the Internet to one or more Seller Computers 310(1), 310(2) . . . 310(m). In turn each Buyer Computer 210 and Seller Computer 310 is connected over the Internet to a programmed Confidential Processor 101 which is maintained by the Confidential Transaction Provider 100 and is programmed to implement the functions of the Confidential Transaction Provider 100. In addition to maintaining the Confidential Processor 101, the Confidential Transaction Provider 100 maintains a Database 102, in connection with the confidential processor, which is used to process the confidential transactions. Within the Database 102, a Buyer's Record 600 (FIG. 7) stores information about each Buyer 200 who registers with the Confidential Transaction Provider 100. The Buyer's Record 600 contains a unique buyer identification number, a password, the buyer's name, address, and contact information, an internal credit rating maintained by the Confidential Transaction Provider 100, Social Security number, one or more credit card numbers to be used to consummate a transaction; and shipping information. Similarly, a Seller's Record 610 (FIG. 8) stores information about each Seller 300 who registers with the Confidential Transaction Provider 100. The Seller's Record 610 contains a unique seller identification number, a password, the seller's name, address and contact information, an internal credit rating, a specified payment method, Social Security number if seller is an individual, and shipping information. A Credit Card Record 620 (FIG. 9) contains, for each buyer 200, credit/debit account information pertaining to one or more credit card companies. A Financial Transaction Record 630 (FIG. 10) includes information which is generated for each financial transaction and stored in the Database 102. The Financial Transaction Record contains for each transaction a unique Confidential Transaction Number which the Confidential Transaction Provider 100 generates automatically for each transaction, the buyer's identification and the credit card selected by buyer are identified, the price quoted by buyer, whether the transaction involves a single payment or repetitive payments, an expiration date and authorization details, the seller's identification and price of goods/services, final approval details, seller's credit card identification information to be used to pay shipper, shipment cost, shipper's address and authorization details, an indication of final credit card approval, shipper's identification, tracking details, and expected pick-up and delivery dates. Finally, a Shipper Record 640 (FIG. 11) contains information about each Shipment Service Provider 500 who registers with the Confidential Transaction Provider 100. The Shipper's Record contains a unique shipper identification number, the shipper's name, address and contact information, a payment method and details specified by shipper, a tracking process identification number used to track each shipment, and one or more shipment methods. FIG. 2 also illustrates that Shipment Service Processor 510, operated by the Shipment Service Provider 500, is connected to the Confidential Transaction Provider 100 over the Internet, while a Credit/Debit Card Processor 410 operated by the Credit Card Company 400 is in direct electronic communication with the Confidential Transaction Provider 100.

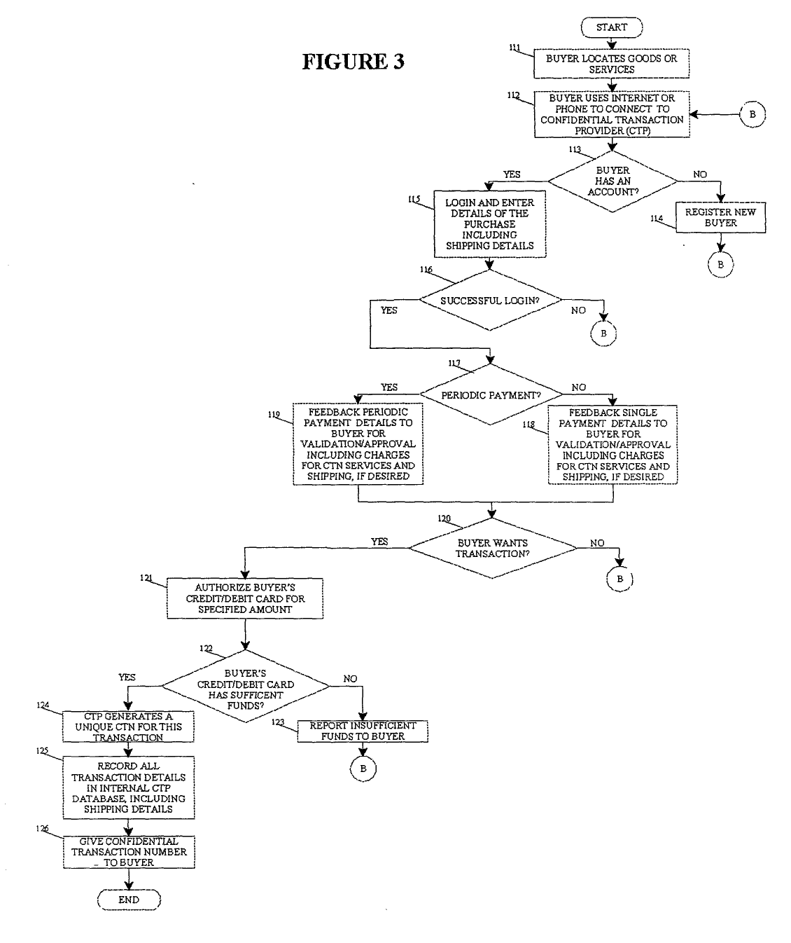

As shown in FIG. 3, a commercial transaction is initiated at step 111 by Buyer 200 operating one of the Buyer Computers 210(1), 210(2) . . . 210(n), for Example 210(1), coupled to the Internet, in order to locate certain goods and/or services being offered for sale by Seller 300 operating one of the seller computers 310(1), 310(2) . . . 310(m), for Example 310(1), also coupled to the Internet. Once the Buyer 200 selects goods and/or services for purchase, Buyer 200 may be prompted by seller to use a CTN to consummate the purchase or Buyer 200 may otherwise be motivated to do so. In either event, Buyer 200 uses his or her Computer 210(1), to contact the Confidential Processor 101, operated by the Confidential Transaction Provider, by using the processor's unique Universal Resource Locator (“URL”). At step 113, the programmed Confidential Processor 101 determines if the Buyer 200 is a registered customer by searching the Buyer's Record 600 of Database 102. If Buyer 200 is not registered, Buyer 200 is registered at step 114 by obtaining buyer's name, a preferred and alternate mailing address, email address, home and work telephone number, Social Security number and shipping instructions, and the information is stored in Buyer's Record 600 of Database 102. The buyer's credit/debit card information is also obtained during registration and stored in the Credit Card Record 620. In order to protect the confidentiality of buyer's registration information when it is sent to the Confidential Transaction Provider 100, Buyer 200 may send the information “off-line” by using the telephone, facsimile, or mail. If an “on-line” Internet connection is used, the Confidential Transaction Provider 100 may provide Buyer 200 with the option to use an encryption scheme. If Buyer 200 is registered and has established an account with the Confidential Transaction Provider 100, Buyer 200 is permitted to login at step 115 and provide the Confidential Processor 101 with a description and purchase price of the goods and/or services he or she wants to purchase, the identity of Seller 300 and, if shipping services are desired, the weight and location of the goods. At step 116, the Confidential Processor 101 determines if the Buyer 200 has successfully logged in by providing all of the information required at step 115. If the login is not successful, the Processor 101 returns the Buyer 200 to step 112, permitting Buyer 200 to try again or initiate another transaction.

If login is successfully accomplished, the programmed Confidential Processor 101 at step 117 queries the Buyer 200 to determine if the purchase involves making periodic payments to Seller 300. If the purchase does not involve periodic payments, the Processor 101 at step 118 asks the Buyer 200 to validate the information he or she has provided about the purchase, and at step 120 asks the Buyer 200 if he or she wants to proceed with the transaction. If Buyer 200 declines to proceed, the Processor 101 again returns control to step 112. If Buyer 200 agrees to proceed, the Processor 101 contacts the buyer's credit/debit card Processor 410 at step 121. At step 122 the Credit/Debit Card Processor 410 determines if the Buyer 200 has sufficient credit to pay for the proposed transaction (i.e., the purchase price of the goods/services, shipping costs if confidential shipping is desired, and a transaction fee charged by the Confidential Transaction Provider 100). If buyer's funds or credit is insufficient, the Processor 101, at step 123, returns control of the system to step 112, allowing Buyer 200 to initiate another transaction. If the Credit/Debit Card Processor 410 determines, however, that sufficient funds or credit exists, the Confidential Processor 101 generates, at step 124, a unique Confidential Transaction Number (“CTN”), using a random number generator. The CTN is assigned a monetary value equal to the sum of the purchase price of the goods and/or services, shipping costs if confidential shipping is desired, and the transaction fee charged by the Confidential Transaction Provider 100. At step 125, the Confidential Processor 101 records the details of the transaction, including the CTN and a date and time limit on its use in the Financial Transaction Record 630. Then, at step 126, the Confidential Processor 101 sends the CTN to Buyer Computer 210(1), which is being operated by Buyer 200.

If at step 117 the Buyer 200 elects to make periodic payments to Seller 300, the Confidential Processor 101 obtains a periodic payment schedule from Buyer 200, validates the information at step 119, and proceeds with steps 120 through 126.

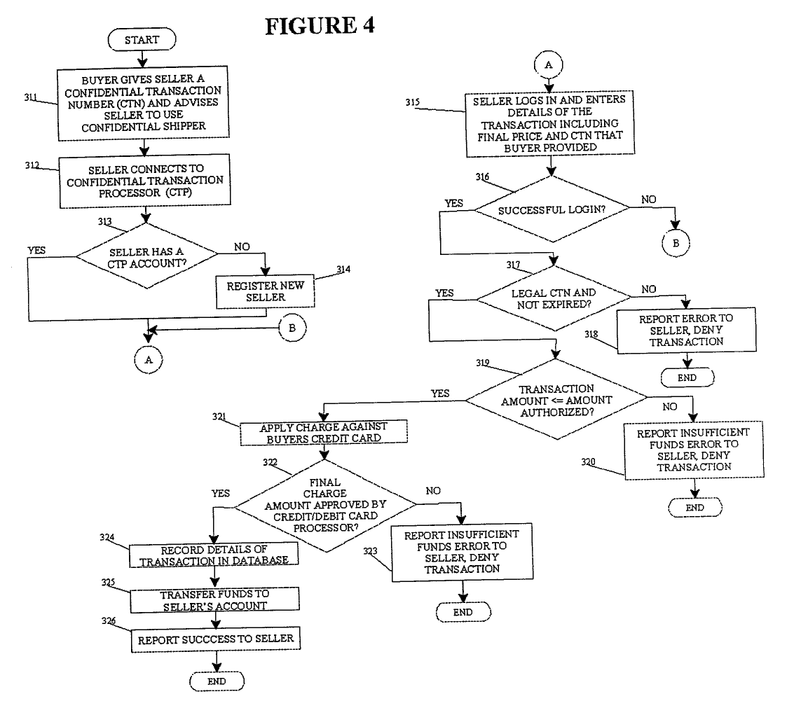

FIG. 4 illustrates the manner in which the buyer's purchase is consummated by using the CTN. At step 311, Buyer 200, again using Buyer Computer 210(1), contacts seller's computer over the Internet and informs Seller 300 that Buyer 200 desires to consummate his/her purchase by using the unique CTN. Buyer then is prompted by Seller 300 to identify the CTN Buyer 200 received from the Confidential Transaction Provider 100 at step 126. Prompted by the desire of Buyer 200 to use the CTN, at step 312, the Seller 300, operating Seller Computer 310(1) contacts the Confidential Processor 101, operated by the Confidential Transaction Provider 100. At step 313, the programmed Confidential Processor 101 determines if the Seller 300 is a registered Seller 300 by searching the Seller's Record 610. If Seller 300 is not registered, Seller 300 is registered at step 314 by obtaining seller's name, address, email address, telephone number, credit rating, preferred payment method and details (e.g., account to be credited for the amount of sale), social security number (if relevant), and shipping information. This information is stored in the Seller's Record 610. Once Seller 300 is registered, Seller 300 at step 315 is permitted to login and provide the Confidential Processor 101 with the CTN and a description and purchase price of the goods and/or services that are being sold. At step 316, the programmed Processor 101 determines if the Seller 300 has successfully logged in by providing all of the information required at step 315. If the login is not successful, the Processor 101 returns the Buyer 200 to step 315, permitting Buyer 200 to try again.

If login is successful, the programmed Processor 101 at step 317 searches the Financial Transaction Record 630 of Database 102 to determine if the CTN provided by the Seller 300 matches the CTN provided to Buyer 200, i.e., was actually issued to Buyer 200. The expiration date and time is also checked to ensure that the CTN is still valid. If the CTN is not valid, the Seller 300 is advised at step 318 by Processor 101 to deny buyer's request to purchase. If the CTN is valid and not expired, at step 319 the Processor 101 compares the monetary value of the CTN to the price of the goods and/or services. If the monetary value of the CTN is less than the price, the Processor 101 reports to seller's computer, at step 320, that an insufficient CTN value has been issued in error and the transaction is denied. If the processor determines that the CTN's monetary value is equal to or greater than the seller's price plus the Confidential Transaction Provider's fee, the Processor 101 at step 321 again contacts the Credit/Debit Card Processor 410 operated by the Credit Card Company 400 which determines at step 322 if the payment account of Buyer 200 still has sufficient funds or credit to satisfy the monetary value of the CTN. If the payment account is now insufficient, the Seller 300 is informed and the transaction is denied at step 323. If the buyer's payment account is still adequate, the account is charged by the monetary value of the CTN and at step 324 the Confidential Processor 101 stores the details of the transaction to the Financial Transaction Record 630. At step 325, the Confidential Transaction Provider 100 credits seller's account by an amount equal to the monetary value of the CTN, less the Confidential Transaction Provider's fee, and at step 326 the Seller 300 is informed that the sale has been successfully completed.

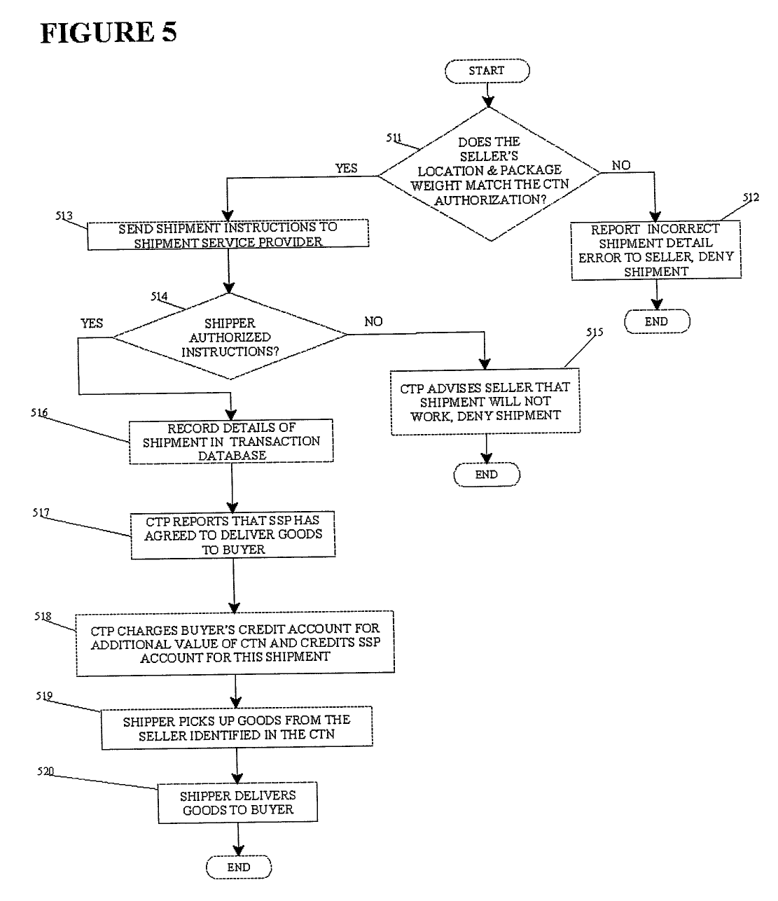

If the Buyer 200 previously indicated, however at step 115 that he/she desired to use the services of the Shipment Service Provider 500 to pick up and deliver goods to Buyer 200, as illustrated in FIG. 5, the Seller 300, operating Seller Computer 310(1), at step 511 sends seller's location (i.e., zip code) and shipment weight information to the Confidential Processor 101 which compares the information to the information previously received from Buyer 200 and stored in the Financial Transaction Record 630 of Database 102. If seller's information matches the financial transaction information stored in the database, the shipment is authorized by the Confidential Transaction Provider 100. If no match is found, authorization is denied and at step 512, and the Confidential Transaction Provider 100, operating Processor 101 sends an error message to Seller Computer 300(1) that incorrect shipment information has been sent. Once the shipment is authorized the Confidential Transaction Provider 100 operating Processor 101 sends shipping instructions at step 513 to the Shipment Service Provider's Processor 510. Upon receipt of the request, the Shipment Service Provider 500 responds at step 514 by either accepting or denying the job. If the Shipper 500 turns down the request, the Confidential Transaction Provider 100 at step 515 informs Seller 300 that the goods will not be picked up by Shipper 500. If the job is accepted, at step 516 the Confidential Transaction Provider 100, operating Processor 101, records the details of the shipment in the Financial Transaction Record 630 of Database 102, and at step 517 advises Seller 300 that the Shipper 500 has agreed to deliver the goods to Buyer 200. The Shipment Service Provider 500 is paid by the Confidential Transaction Provider 100 at step 518 by charging buyer's credit/debit account for the additional value of the CTN (i.e., shipping cost) and credits shipper's account for the shipment. Finally, at steps 519 and 520, respectively, the Shipment Service Provider 500 uses the CTN to identify and pick up the goods from Seller 300 and deliver them to Buyer 200.

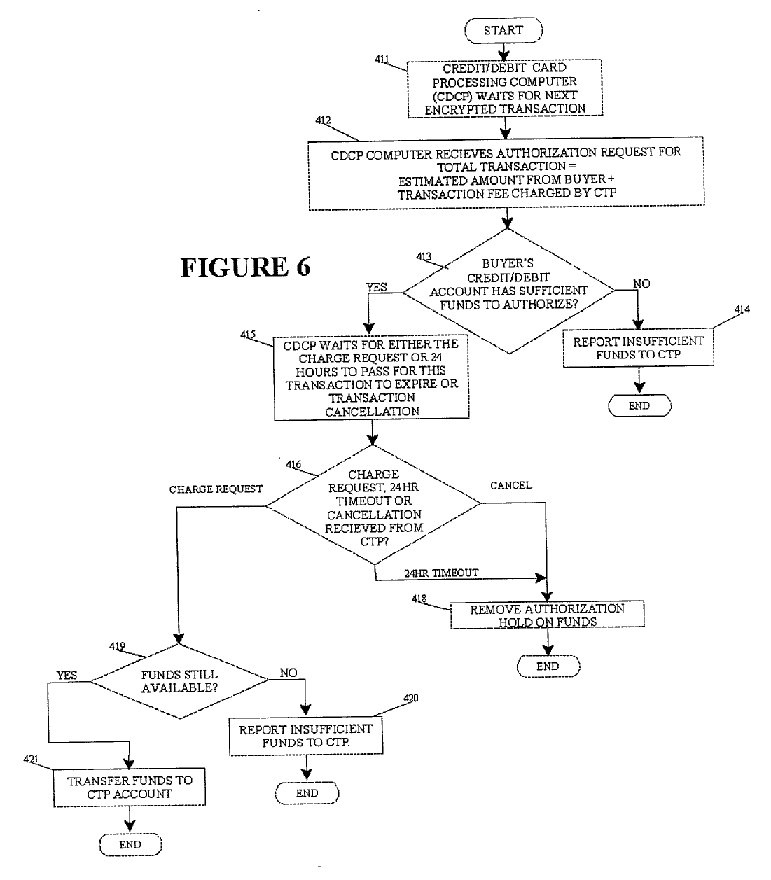

FIG. 6, steps 411 through 421, illustrate the manner in which the Confidential Transaction Provider 100 obtains an authorization from the Credit Card Company 400 to transfer funds from buyer's credit/debit card account to the Confidential Transaction Provider 100 account. At step 411, the Credit/Debit Card Processor 410, which is in electronic communication with Confidential Transaction Provider 100, is programmed to process payment requests. At step 412, the Credit/Debit Card Processor 410 receives a request over the network from the Confidential Transaction Provider 100 for the payment of the buyer's estimated amount to consummate a purchase, plus the amount of the transaction fee charged by the Provider 100. At step 413, the Credit/Debit Card Processor 410 determines if the Buyer 200 has sufficient funds or credit to pay for the goods/services. If the funds or credit are insufficient, the Credit Card Company 400 issues a report, at step 414, to the Confidential Transaction Provider 100 of that fact and the requested purchase is denied. If the Buyer 200 does have sufficient funds or credit, at step 415, the Credit/Debit Card Processor 410 waits for a request from the Confidential Transaction Provider 100 to either charge the account of Buyer 100 or waits for twenty-four (24) hours to elapse during which time period no charge request is made. If at step 416, it is determined by Processor 410 that no charge request was made within the time period, the Processor 410 at step 418 removes the authorization hold on the funds of Buyer 200. On the other hand, if at step 416 a charge request is received, the Processor 410 again determines at step 419 if the Buyer 200 still has sufficient funds or credit available to pay for the goods/services, plus the transaction fee of the Confidential Transaction Provider 100. If the funds or credit are available, the funds are transferred at step 421 to the Confidential Transaction Provider 100. If the funds are not sufficient, the Credit/Debit Card Company, at step 420, issues a report of insufficient funds to the Confidential Transaction Provider 100.

Although the present invention has been fully described by way of example in connection with a preferred embodiment, various charges and modifications would be apparent to those persons who are skilled in the art. Such charges and modifications should be construed as included within the scope of the present invention as defined by the appended claims.

What is claimed is:

1. A method of enabling a buyer to purchase goods and/or services from a seller comprising:
a) issuing a confidential transaction number from a confidential transaction provider to the buyer, said confidential transaction number having a predetermined monetary value;
b) prompting the buyer to provide the confidential transaction number to the seller;
c) prompting the seller to provide the confidential transaction number to the confidential transaction provider;
d) verifying that the confidential transaction number issued to the buyer matches the confidential transaction number provided by the seller;
e) verifying that the monetary value of the confidential transaction number is sufficient to pay for the seller's goods and/or services;
f) verifying that a buyer's payment account contains funds or credit having a monetary value equal to or greater than the monetary value of the confidential transaction number;
g) transferring payment funds from buyer's payment account to the confidential transaction provider;
h) transferring said payment funds from the confidential transaction provider to the seller; and
i) providing the goods and/or services from the seller to the buyer.

2. The method of claim 1 in which the buyer's payment account is a credit account.

3. The method of claim 1 in which the buyer's payment account is a debit account.

4. A method of enabling a buyer to purchase goods from a seller comprising:
a) issuing a confidential transaction number from a confidential transaction provider to the buyer, said confidential transaction number having a predetermined monetary value;
b) prompting the buyer to provide the confidential transaction number to the seller;
c) prompting the seller to provide the confidential transaction number to the confidential transaction provider;
d) verifying that the confidential transaction number issued to the buyer matches the confidential transaction number provided by the seller;
e) verifying that the monetary value of the confidential transaction number is sufficient to pay for the goods and pay for delivery of the goods;
f) verifying that a buyer's payment account contains funds or credit having a monetary value equal to or greater than the monetary value of the confidential transaction number;
g) transferring payment funds from buyer's payment account to the confidential transaction provider;
h) transferring a first portion of said payment funds from the confidential transaction provider to the seller to pay for the goods;
i) transferring a second portion of said payment funds from the confidential transaction provider to a shipper to pay for the cost to deliver the goods to the buyer;
j) providing the confidential transaction number to the shipper to be used to identify goods to be picked up from the seller; and
k) prompting the shipper to pick up the goods from the seller and deliver them to the buyer.

5. The method of claim 4 in which the buyer's payment account is a credit account.

6. The method of claim 4 in which the buyer's payment account is a debit account.

7. A system for enabling a buyer to purchase goods and/or services from a seller over a communications network comprising:
a) a programmed confidential server operated by a confidential transaction provider, a buyer computer operated by a buyer, and a seller computer operated by a seller, said server, buyer computer and seller computer connected over the network;
b) transmitting a confidential transaction number from the programmed confidential server to the buyer computer, said confidential transaction number having a predetermined monetary value;
c) prompting the buyer to transmit the confidential transaction number from the buyer computer to the seller computer;
d) prompting the seller to transmit the confidential transaction number to the confidential transaction provider to verify, using the programmed confidential server, that the confidential transaction number provided by the seller matches the confidential transaction number issued to the buyer;
e) prompting the seller to transmit the purchase price of the goods and/or services to the confidential transaction provider to verify, using the programmed confidential server, that the monetary value of the confidential transaction number is sufficient to pay for the goods and/or services;
f) prompting the confidential transaction provider to contact a buyer's purchase account to verify that the account contains funds or credit having a monetary value equal to or greater than the monetary value of the confidential transaction number;
g) transmitting payment funds from buyer's payment account to the confidential transaction provider;
h) transmitting said payment funds from the confidential transaction provider to the seller; and
i) providing the goods and/or services from the seller to the buyer.

8. The system of claim 7 in which the buyer's payment account is a credit account.

9. The system of claim 7 in which the buyer's payment account is a debit account.

10. A system for enabling a buyer to purchase goods from a seller over a communications network comprising:
a) a programmed confidential server operated by a confidential transaction provider, a buyer computer operated by a buyer, and a seller computer operated by a seller, said server, buyer computer and seller computer connected over the network;
b) transmitting a confidential transaction number from the programmed confidential server to the buyer computer, said confidential transaction number having a predetermined monetary value;
c) prompting the buyer to transmit the confidential transaction number from the buyer computer to the seller computer;
d) prompting the seller to transmit the confidential transaction number to the confidential transaction provider to verify, using the programmed confidential server, that the confidential transaction number provided by the seller matches the confidential transaction number issued to the buyer;
e) prompting the seller to transmit the purchase price of the goods to the confidential transaction provider to verify, using the programmed confidential server, that the monetary value of the confidential transaction number is sufficient to pay for the goods;
f) prompting the confidential transaction provider to contact a buyer's purchase account to verify that the account contains funds or credit having a monetary value equal to or greater than the monetary value of the confidential transaction number;
g) transmitting payment funds from buyer's payment account to the confidential transaction provider;
h) transmitting a first portion of said payment funds from the confidential transaction provider to the seller to pay for the goods;
i) transmitting a second portion of said payment funds from the confidential transaction provider to a shipper to pay for the cost to deliver the goods to the buyer;
j) providing the confidential transaction number to the shipper to be used to identify goods to be picked up from the seller; and
k) prompting the shipper to pick up the goods from the seller and deliver them to the buyer.

11. The system of claim 10 in which the buyer's payment account is a credit account.

12. The system of claim 10 in which the buyer's payment account is a debit account.

13. A method of enabling a buyer to purchase goods and/or services from a seller comprising:
a) issuing a confidential transaction number from a confidential transaction provider to the buyer, said confidential transaction number having a predetermined monetary value;
b) prompting the buyer to provide the confidential transaction number to the seller;
c) prompting the seller to provide the confidential transaction number to the confidential transaction provider;
d) verifying that the confidential transaction number issued to the buyer matches the confidential transaction number provided by the seller;
e) verifying that the monetary value of the confidential transaction number is sufficient to pay for the seller's goods and/or services and to pay for a transaction fee;
f) verifying that a buyer's payment account contains funds or credit having a monetary value equal to or greater than the monetary value of the confidential transaction number;
g) transferring payment funds from buyer's payment account to the confidential transaction provider;
h) transferring a first portion of said payment funds from the confidential transaction provider to the seller to pay for the goods and/or services;
i) retaining a second portion of said funds by the confidential transaction provider to pay for the transaction fee; and
j) providing the goods and/or services from the seller to the buyer.
